(19) United States
(12) Patent Application Publication
(10) Pub. No.: US 2008/0071691 A1
(43) Pub. Date: Mar. 20, 2008

(54) Method and Device for Franking Postal Items

(75) Inventors: Bernd Meyer, Konlgswinter (DE); Jurgen Lang, Bergisch Gladbach (DE)

Correspondence Address: FLETCHER YODER, P.O. BOX 692289, HOUSTON, TX, 77269-2289, US

(73) Assignee: DEUTSCHE POST AG, 53113 Bonn (DE)

(21) Appl. No.: 11/663,307

(22) PCT Filed: Aug. 15, 2005
(86) PCT No.: PCT/EP05/08846

§ 371 Date: Oct. 10, 2007

(30) Foreign Application Priority Data
Sep. 21, 2004 (DE) 10 2004 046 018.3

(51) Int. Cl. G07B 17/02; G07B 17/04; H04L 9/32

(52) U.S. Cl. 705/62

(57) ABSTRACT

The disclosure relates to a system and method for franking mail. An exemplary method for franking mail comprises generating a printing master copy of a postage indicium, encrypting the printing master copy of the postage indicium, transmitting the printing master copy to an operating unit, together with a request that, after the postage indicium has been printed out, information about the printing of the postage indicium is to be stored, decrypting the printing master copy in a secure area of the operating unit in order to print the postage indicium, whereby the secure area is a component of a universal standard program for displaying and/or printing text and/or graphic elements, and responsive to a request for printing the postage indicium, storing information about the printing in the printing master copy and/or in an authorization database, whereby the printing of the postage indicium is blocked if the information about the printing is already present.

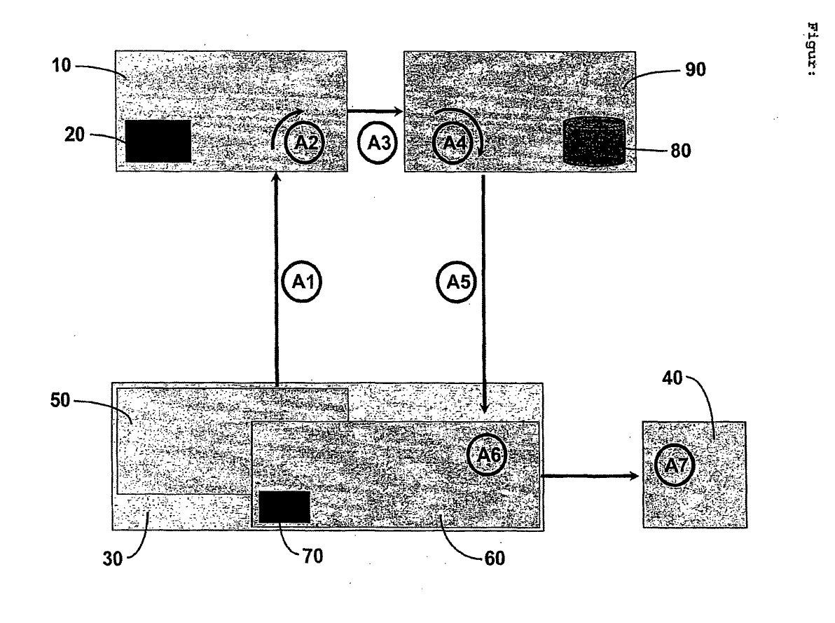

### CROSS REFERENCE TO RELATED APPLICATIONS

This application claims priority to German (DE) Patent Application No. 10 2004 046 018.3, filed Sep. 21, 2004, the contents of which are incorporated by reference as if set forth in their entirety herein. This application is the U.S. national phase of International Patent Application No. PCT/EP2005/008846, filed on Aug. 15, 2005, the contents of which are hereby incorporated by reference as if set forth in their entirety herein.

### BACKGROUND

The invention relates to a method for franking mail in which a postage indicium is requested by an operating unit, generated in a security module, made available to the operating unit and printed out by means of the operating unit and/or a printing unit.

The invention also relates to a device for franking mail, with a franking unit for generating a postage indicium, with an operating unit connected to the franking unit and with a printing unit connected to the operating unit in order to print the postage indicium.

Various methods and devices of the same type are known for franking mail with digital postage indicia, whereby certain measures are intended to ensure that authentic postage indicia are generated in a customer system, and that the applicable payment has been made to a postal service provider for said postage indicia.

For example, German patent specification DE 100 20 566 C2 of the applicant discloses a method for franking mail in which a postage indicium is generated in a customer system using a crypto-string that, on the basis of secret information generated in a security module of the customer system, has been generated in a value transfer center of a postal service provider and encrypted in such a way that it can only be decrypted in a verification center of the postal service provider. The postage indicium, which contains especially the crypto-string, mailing-specific information as well as a checksum, is generated in the security module of the customer system. With this method, a renewed printing of a postage indicium is prevented in a non-specified manner.

International patent application WO 00/31693 describes a method for franking mail by means of a franking machine that is equipped with a secure module. In order to generate a predefined quantity of postage indicia, a postal service provider supplies a number that is encrypted or else protected with a checksum and that is evaluated with a corresponding key when the postage indicium is checked. Postage indicia are generated in the security module, making use of the number and, in this process, it is ensured within the module, for example, by deleting the number, that no postage indicia beyond the predefined quantity can be generated on the basis of this number.

A multiple printing of postage indicia as so-called duplicates is especially prevented in the prior-art methods in that printable postage indicia are generated by means of special hardware and/or software of the systems operated by a customer and they can be printed out in a manner that is controlled by the special hardware and software. The suppression of duplicates is thus based on linking the generation of the postage indicium with the generation of a printing master copy of the postage indicium and with the subsequent printing of the postage indicium by means of the hardware and/or software.

The generation of the printable postage indicia in the area of the systems operated by the customer, however, is associated with non-secure aspects that do not arise in the case of a central generation of printable postage indicia in the area of influence of the supplier of such postage indicia. Moreover, the provision of the special hardware and/or software for the systems that are located at the premises of the customer entails additional effort for the supplier of the postage indicium and for the customer, and the customer is not able to frank mailpieces with operating units that are not equipped in this special manner.

### SUMMARY OF THE INVENTION

Therefore, the invention is based on the objective of permitting the most manipulation-proof possible printing of postage indicia in an operating unit, even if the operating unit is not specially equipped for generating and printing out printable postage indicia. In particular, the printing of duplicates is to be prevented.

In accordance with the invention, this objective is achieved by a method according to Claim 1.

In accordance with the invention, this objective is also achieved by a device according to Claim 18.

Advantageous refinements of the method and of the device are the subject matter of the subordinate claims.

In particular, the invention proposes that a method for franking mail in which a postage indicium is requested by an operating unit, generated in a security module, made available to the operating unit and printed out by means of the operating unit and/or a printing unit is carried out in such a way that a printing master copy of the postage indicium is generated and encrypted, that the printing master copy is decrypted in the operating unit in order to print the postage indicium and that, after the postage indicium has been printed out, information about the printing is stored, whereby the printing of the postage indicium is blocked if information about the printing is already present.

Such a method has the advantage that a printing master copy containing the postage indicium can be made available to the operating unit in order to print the postage indicium, and a renewed printing of the postage indicium is prevented through the presence of the information about the printing that was stored after the first time the postage indicium was printed out. In this process, the encryption can advantageously ensure that the postage indicium is only printed out in the area of those operating units that comply with the information about the printing as a control command for blocking the printing. The term encryption here is to be understood here in its broadest sense and, in addition to cryptographic methods, especially also includes steganographic methods.

With this method, it is especially advantageous that, before the postage indicium is printed out, a verification is carried out as to whether information about the printing is already present. In this manner, it is reliably ensured that the postage indicium cannot be printed out anew.

An advantageous embodiment of the method provides that the information about the printing of the postage indicium is incorporated into the printing master copy. In this manner, this information is permanently linked to the printing master copy and a renewed printing out is reliably prevented, even if the printing master copy is stored after the printing and if, at a later point in time, a printing procedure is initiated anew.

In order to ensure that a multiple printing on several operating units is prevented, even if the printing master copy is duplicated before the printing procedure, it is advantageously provided that the printing master copy is encrypted in the secure area in such a way that it can only be decrypted in the operating unit from which the postage indicium has been requested.

In an especially preferred embodiment of the method, it is provided that the information about the printing of the postage indicium is stored in a database.

This makes it possible to centrally store the information about the printing separately from the printing master copy, as a result of which the manipulation security of the method is further enhanced. Thus, in this embodiment, the information about the printing is complied with by all of the operating units that are fundamentally capable of printing out the postage indicium.

Moreover, there is no need for a so-called personalized encryption in which the printing master copy can only be decrypted by one specific operating unit. Here, it is sufficient to encrypt the printing master copy in such a manner that it can only be decrypted by operating units that are configured in such a way that they store the information about the printing that blocks any renewed printing after the printing procedure and that they comply with this information.

Advantageously, in order to carry out the method, operating units are used that are not equipped in a specific manner for printing out mailpieces.

Therefore, in the next advantageous embodiment of the invention, it is provided that the printing master copy is transmitted to the operating unit, together with a request to the effect that, after the postage indicium has been printed out, the information about the printing of the postage indicium is to be stored.

Advantageously, it is provided that, as a function of the request, after the postage indicium has been printed out, the information about the printing is incorporated into the printing master copy and/or a notification about the printing is transmitted to the database. Preferably, as a function of the notification about the printing, the information about the printing is stored in the database.

In order to prevent a manipulation of the request, the request is preferably encrypted in the secure area and decrypted in a secure area of the operating unit.

Advantageously, in one embodiment of the method, the request is incorporated into the postage indicium.

In another advantageous embodiment of the method, the request is incorporated into an encrypted license that is decrypted in the operating unit. The use of the license here especially has the advantage that it is possible for the printing master copy to be decrypted in the area of the operating unit using a key that is incorporated into the license. Moreover, the information about the printing of the postage indicium can advantageously be incorporated into the license.

In a preferred embodiment of the method, the printing master copy and/or the license are encrypted by means of a so-called asymmetrical encryption method. Preferably, it is provided here for the printing master copy and/or the license to be encrypted using a public key of the operating unit. Preferably, it is also provided here for the printing master copy and/or the license to be decrypted using a private key of the operating unit. In this context, this can be an individual private key of the specific operating unit or else a private key of a plurality of operating units that are configured in such a way that they store the information about the printing of the postage indicium that blocks printing after the postage indicium has been printed out and so they comply with this information.

In another embodiment of the method, a symmetrical method for encrypting the printing master copy and/or the license is carried out. Here, preferably the printing master copy and/or the license are encrypted and decrypted using identical keys.

In order to even further enhance the manipulation security of the method, in an advantageous embodiment of the method, it is provided that the postage indicium is canceled in the operating unit after being printed out. Even if someone manages to print out the content of the printing master copy anew, this prevents the printout from containing a valid postage indicium.

In addition to the method, the invention also proposes a device.

The device for franking mail, with a franking unit comprising a security module for generating a postage indicium, with an operating unit connected to the franking unit and with a printing unit connected to the operating unit in order to print the postage indicium is especially characterized in that the security module is connected to an authorization unit for generating an encrypted printing master copy containing the postage indicium, in that the operating unit encompasses a secure area, in that the secure area has a means for decrypting the printing master copy, in that the secure area has a control means for controlling the printing unit, in that the secure area has a means for storing information about the printing of the postage indicium and in that the secure area has a means for checking for the presence of information about the printing of the postage indicium, said means blocking the control means that controls the printing unit if information about the printing of the postage indicium is already present.

Advantageously, in particular, a secure area within the operating unit is provided with which it can be ensured that the information about the printing that blocks the printing is stored within the operating unit after the printing and that the information is complied with. The term secure area is to be understood here in its broadest sense and especially includes the implementation as a cryptographic module or as an area in which data is protected against access and manipulation by means of concealed processing.

The secure area is preferably a component of a universal standard program for displaying and/or printing text and/or graphic elements, so that the operating unit for franking mail can be operated without special equipment.

In an especially preferred embodiment of the device, the authorization unit contains a database for storing the information about the printing of the postage indicium.

Here, the authorization unit is preferably operated centrally with the above-mentioned advantages and is thus connected to a plurality of operating units. Advantageously, the authorization unit, like the franking unit, is operated by the supplier of the postage indicium; it can also be integrated into the franking unit.

In an especially advantageous embodiment of the device, the means for storing the information about the printing of the postage indicium sends a notification about the printing to the database.

In another advantageous embodiment of the device, the means for checking for the presence of the information about the printing of the postage indicium performs a query as to the presence of information about the printing of the postage indicium in the area of the database.

Additional advantages, special features and advantageous refinements of the invention can be gleaned from the subordinate claims and from the presentation below of preferred embodiments making reference to the single FIGURE.

### BRIEF DESCRIPTION OF THE DRAWING

This FIGURE shows a schematic representation of the components for carrying out a method according to the invention and their interaction.

### DETAILED DESCRIPTION OF SPECIFIC EMBODIMENTS

The reference numeral 10 in the FIGURE refers to a franking unit comprising a security module 20, a so-called cryptographic module, for generating cryptographically secure information that is incorporated into the postage indicium to be generated and that allows a reliable verification of the validity of the postage indicium. The franking unit 10 is operated centrally by a supplier of postage indicia and allows the generation of postage indicia for a plurality of customers that each access functions of the franking unit 10 via an operating unit 30.

Customer postage accounts containing a postage amount that is loaded from a value transfer center of a postal service provider and that can be used for generating postage indicia are administrated in a security module 20 of the franking unit 10. During the loading procedure, in particular, a crypto-string is transmitted from the value transfer center to the security module 20, said crypto-string containing data that is encrypted in such a way that it can only be decrypted in a verification center of the postal service provider. Making use of the loaded postage amount, postage indicia that are printed out by the customer with the operating unit 30 and/or a printing unit 40 are generated using the crypto-string and other data that still has to be indicated. Particularly on the basis of the crypto-string, it is possible to check whether a postage indicium is authentic and whether the postage for the postage indicium has been paid.

A suitable method for generating the crypto-string and for generating secure postage indicia on the basis of the crypto-string to which reference is made here by way of example is described in the German patent specification DE 100 20 566 C2 of the applicant. With this method, secret information, for example, a random number, is generated in the security module 20 and transmitted via a secure data connection to the value transfer center that incorporates the random number and a loading procedure identification number into the crypto-string. The crypto-string and the loading procedure identification number are sent back via the secure connection to the security module 20 and stored there together with the random number in order to generate postage indicia.

The franking unit 10 and the operating unit 30 are connected to each other within a wide area network (WAN) such as, for example, the Internet, via which data exchange takes place in a manner generally known to the person skilled in the art.

The operating unit 30 is a personal computer (PC) that especially has a processor for performing calculations, an input means and a display means, a volatile memory and generally also a non-volatile memory. The printing unit 40 is connected to the operating unit 30 via a data cable or a computer network. It is equipped with means known to the person skilled in the art for printing out text and graphic elements, said means being controlled by control commands that are transmitted from the operating unit 30 to the printing unit 40.

The operating unit 30 provides a so-called browser 50 that is capable of displaying the contents of websites on the display means of the operating unit 10, of controlling the printing of contents of websites in the printing unit 40 and of executing control commands contained in the websites. The browser is likewise configured in a manner known to the person skilled in the art.

Moreover, the operating unit 30 provides a reader 60 that is capable of displaying text and graphic elements contained in printing master copies in a standard format on the display means of the operating unit 30 and of controlling their printing in the printing unit 40. Examples of standard formats that can be interpreted by the reader 60 are, for example, the familiar Portable Document Format (PDF) or the familiar postscript format. Moreover, the printing master copy can be configured in a standard format that is used by a standard word processing program such as, for instance, the “WORD” program made by the Microsoft company.

Moreover, the reader 60 is able to record and comply with information about access rights that are linked to the printing master copy and that are indicated in the form of predefined parameters and/or predefined values of parameters. For this purpose, the reader 60 provides in the operating unit 30 a secure area that is protected by software and/or hardware in the form of a cryptographic module 70, where, with each step for preparing or processing the printing master copy, the parameters relating to the rights to perform this step are checked.

Instead of a cryptographic module as such, the reader 60 can also provide an area in which data is protected against access and manipulation by means of concealed processing. However, below the term cryptographic module will be used for the secure area of the reader 60.

The preparation or processing steps are likewise controlled by the cryptographic module 70 in order to prevent access to functions that have been made available by the reader 60 for which no authorizations exist.

The compliance with the access rights that are linked to the printing master copy is secured in a reliable manner exclusively within the cryptographic module 70. Therefore, the possibility of access to the printing master copy outside of the cryptographic module 70 is prevented in that the printing master copy is encrypted in such a way that it can be decrypted exclusively in the cryptographic module 70.

The reader 60 is preferably a universal standard program that is not equipped in a special manner for printing out postage indicia. Therefore, the rights that are necessary for a manipulation-proof printing of postage indicia are not permanently implemented in the reader 60 but rather the information about these rights is incorporated into the printing master copy or else transmitted to the operating unit 30 within a license separately from the printing master copy. The cryptographic module 70 of the reader 60 reads this information and, in particular, the parameters and/or the values of parameters contained in the information. In order to allow an association between the license and the printing master copy, a feature that unambiguously identifies the printing master copy is incorporated into the printing master copy as well as into the license. In order to rule out manipulations, this feature is likewise encrypted in such a way that it can only be decrypted in the cryptographic module 70.

In order to prevent a manipulation of the information about the access rights, it is proposed to likewise encrypt this information in such a way that it can only be decrypted in the cryptographic module 70.

In another embodiment of the invention, it is proposed that the encrypted printing master copy or the license merely contains an indication of limited access rights, and that the appertaining parameters and/or the appertaining values of parameters are stored in a secure area of a preferably centrally operated authorization database 80 that is contained, for instance, in an authorization unit 90. In order to prevent manipulation of this authorization database 80, the indication is likewise encrypted in such a way that it can only be decrypted in the cryptographic module 70.

In this embodiment, the cryptographic module 70 accesses the centrally stored information about the access rights, whereby with each step for preparing or processing the printing master copy, a query as to the authorization to perform this step is sent from the cryptographic module 70 to the authorization unit 90. On the basis of the query, the authorization unit 90 checks in the authorization database 80 whether the step is allowed to be performed or not, and sends a message containing the result of the verification to the cryptographic module 70 of the reader 60, and the module then complies with the result. The query is transmitted indicating a feature that unambiguously identifies the printing master copy and the authorization unit 90 checks the authorization on the basis of an association stored in the authorization database 80 between the identification feature and the information about the access rights linked to the printing master copy in question.

Moreover, in this embodiment, regarding the encryption of the printing master copy and/or of the license, a public key of a key pair that is uniform for all readers of the type of reader 60 can be used for asymmetrical encryption, since the access rights linked to the printing master copy are administered centrally in the authorization database 80. If no authorization database 80 is used, an individual encryption has to be carried out for each individual reader 60 in order to ensure that the content of the printing master copy is only printed out once. Otherwise it would be possible to duplicate the printing master copy before the printing and to make it available to several readers 60 that each print out the content of the printing master copy one time, independently of each other.

Furthermore, the information about access rights that are linked to printing master copies containing postage indicia can likewise be implemented in the reader 60 and the encrypted printing master copy with the postage indicium can be marked by an appropriate annotation as a printing master copy the contains a postage indicium. In this process, the information about the access rights is stored in the non-volatile memory of the operating unit 30, whereby the information is, in turn stored encrypted in such a way that it can only be decrypted in the cryptographic module 70 of the reader 60. In the same manner, in this embodiment of the invention, the annotation that marks the content of the printing master copy as being a postage indicium is encrypted.

In order to encrypt the printing master copy containing the information about the access rights or the annotation, an asymmetrical encryption process is preferably used. Here, a key pair is used that consists of a secret, so-called private key, and a so-called public key that is accessible to a third party. The keys are related to each other in such a way that a file encrypted with the public key can exclusively be decrypted with the private key. The private key is associated with the reader 60 and is implemented in the reader 60 in such a way that it cannot be read out and is only available for decryption in the cryptographic module 70 of the reader 60. The keys can be generated by means of methods known to the person skilled in the art such as, for example, the RSA (Rivest-Shamir-Adleman) method or a method based on elliptical curves.

The encryption based on a symmetrical method for encrypting the printing master copy containing information about the access rights, in which method the encryption and the decryption are carried out on the basis of the same key, is likewise possible, whereby in this case as well, the appertaining key is implemented in the reader in the manner described above.

If a license for indicating the access rights linked to the printing master copy is provided, then it is preferably likewise encrypted on the basis of the asymmetrical method using a key pair whose private key is implemented in the reader 60. However, an encryption on the basis of a symmetrical method using a key that is especially implemented in the reader 60 can, in turn, likewise be carried out.

In another embodiment of the invention, which is based on the use of the license, the possibility exists to encrypt the license in the above-mentioned manner and to additionally incorporate a key into the license for purposes of decrypting the printing master copy. In this embodiment, the printing master copy is preferably encrypted by means of a symmetrical method using a key that is initially not known to the reader 60. The key is only read out of the license after the license has been decrypted. The use of an asymmetrical method for encrypting the printing master copy, however, is likewise possible. The encryption takes place using a key pair whose private key needed for the decryption is initially not known to the reader 60 and which is only read out of the license by said reader 60 after the license has been decrypted.

Regarding the access rights, the printing master copy containing the postage indicium is linked to information in such a way that its content can be printed out one time. Here, this information is incorporated on the basis of an appropriate parameter and/or of an appropriate value of a parameter into the printing master copy or into the license or else stored in the authorization database 80. After the postage indicium has been printed out, however, the parameter or the value of a parameter is changed, whereby the changed parameter or the changed value corresponds to information to the effect that it is not permissible to print out the content of the printing master copy. Here, the printing is controlled by the cryptographic module 70 of the reader 60 and recorded by the cryptographic module 70. The parameter or the value is changed after the printing has been recorded by the cryptographic module 70 or else a notification about the printing is sent to the authorization unit 90 and the parameter or a value of a parameter is changed in the area of the authorization database 80.

In one embodiment of the invention, it can also be provided that, in addition, the cryptographic module 70 at least partially removes the postage indicium from the printing master copy.

In other embodiments of the invention, in order to enhance the manipulation security, it can also be provided that the printing master copy is additionally linked to information to the effect that it is not permissible to store the printing master copy in the non-volatile memory of the operating unit 30, to copy the printing master copy, to remove contents from the printing master copy and/or to export the printing master copy or contents of the printing master copy into a different file format. This information is likewise incorporated as appertaining parameters and/or as appertaining values of parameters into the printing master copy or into the license or else stored in the authorization database 80 of the authorization unit 90. The parameters and/or the values of parameters are not changed during the franking procedure.

An authorization unit 90 is provided in order to indicate the access rights and to encrypt the printing master copy and, if applicable, the license. This authorization unit 90 has the necessary keys and, if applicable, also means to generate keys and to generate features that unambiguously identify the printing master copies. If this is provided for them, the authorization unit 90 can likewise control the authorization database 80.

The authorization unit 90 provides a secure area in which the necessary information, comments and/or features are incorporated into the printing master copy and in which the necessary encryptions are carried out. It is connected to the franking unit 10 via a secure data connection or integrated into said franking unit 10, and it is likewise operated centrally by the supplier of the postage indicia.

In order to request a postage indicium, one or more websites are made available by the franking unit 10 and they are displayed by the browser 50 on the display means of the operating unit 30. Via these websites, the user selects a mailing class for the mailpiece that is to be franked, as well as a document into which the postage indicium is to be incorporated and enters the name and address of a recipient. The websites here are configured as a so-called form that allows entries that are made with the entry means of the operating unit 30 and that controls the transmission of the entries to the franking unit 10.

The document into which the postage indicium is to be incorporated contains at least the name and address of the recipient of the mailpiece in plain text, since this involves information that is needed for generating and verifying the postage indicium. Other text and/or graphic elements that are likewise indicated by the customer can also be incorporated via websites. Examples of documents into which the postage indicium is to be incorporated are, for example, letters, envelopes, address labels or other stickers that are to be applied onto a mailpiece.

After the evaluation of the data entered by the customer, then, in the area of the franking unit 10, a preview can be generated showing the document with the valid postage indicium especially in order to give the user the possibility to check the data. Here, a sample of the postage indicium can be incorporated into the preview, said sample containing a sample barcode into which no validity information has been incorporated and that is marked as a sample, for example, in that it is crossed out.

The preview can be transmitted to the customer via a website that can be printed out and displayed on the display means by the browser 50 or it can be transmitted on the basis of a printing master copy that can be displayed and printed by the reader 60. A restriction of access rights is not provided for the preview.

In a subsequent step, which is illustrated in the FIGURE by the reference numeral A1, a customer requests the printing master copy with the valid postage indicium. This is done via a website provided by the franking unit 10 and displayed by the browser 50 on the display means of the operating unit 30, said website containing, for instance, an appropriate button, and after this button has been actuated, a request for the printing master copy with the postage indicium is transmitted from the operating unit 30 to the franking unit 10.

In order to request the printing master copy with the valid postage indicium, the customer also enters an identification feature and an associated authentication feature comprising, for example, a user name and an associated password that is known only to the customer. This is likewise done via a website that is provided by the franking unit 10 and that is configured as a form where the features can be entered. After the transmission of the features to the security module 20, the identity of the customer is ascertained and verified on the basis of an association between the identification features and the authentication features stored in a database. Moreover, if the verification of the identity is successful, then the postage account of the customer is ascertained on the basis of his identification features.

As an alternative to the above-mentioned embodiment of the invention, regarding the identification and authentication of the customer, it can also be provided that this is carried out in an earlier step, for example, before the selection of the mailing class.

On the basis of the request for the printing master copy, after the successful authentication of the customer and the identification of his postage account in the security module 20 of the franking unit 10, a data record of the postage indicium is created and issued for purposes of generating the postage indicium. This is illustrated by means of reference numeral A2. Here, the data record contains only a byte string; the printing of the data record does not yield a valid postage indicium.

By way of example, it is assumed here that the postage indicium is generated by means of the cryptographic method described in German patent specification DE 100 20 566 C2. However, the person skilled in the art recognizes that the invention can also be used in a similar manner in conjunction with other methods in order to generate digital postage indicia.

In order to generate the data record of the postage indicium, in step A2, the mailing-specific data needed for generating the postage indicium, that is to say, especially the mailing class, the postage amount as well as the name and address of the recipient, is transmitted within the franking unit 10 to the security module 20 on the basis of the request for the printing master copy. After the identification of the postage account, said security module 20 checks on the basis of the mailing-specific data whether the postage account has a sufficient balance.

In order to generate the data record, a checksum is then generated on the basis of the random number, of the loading procedure identification number, of at least excerpts of the mailing-specific data and of the current date. The checksum, the crypto-string and the mailing-specific data that was used to generate the checksum are all incorporated into the data record. Moreover, the balance of the postage account of the customer is reduced by the postage amount during or after the generation of the data record.

The data record issued by the security module 20 as well as the other data provided by the customer for the generation of the document with the postage indicium such as, for example, a document master and the text and/or graphic elements to be incorporated into the document are subsequently transmitted from the franking unit 10 to the authorization unit 90. This is indicated by the reference numeral A3.

In the following step A4, a printing master copy is generated from the data record and from the other data in a secure area of the authorization unit 90 and this printing master copy is provided with the above-mentioned rights and encrypted in the manner described above. By way of example, this is described below, making reference to the embodiment of the invention in which a separate license for indicating the access rights and the key for decrypting the printing master copy are dispensed with, and in which the rights are stored and administered in the authorization database 80. The person skilled in the art recognizes how this can be applied to the other above-mentioned embodiments.

In order to generate the printing master copy, first of all, on the basis of the data record generated in the security module 20, a two-dimensional barcode is generated that is preferably configured as a matrix code. The rules for generating the matrix code from the data record are stored in the authorization unit 90 on the basis of special control commands. The matrix code is incorporated as a graphic element into the document selected by the customer and, on the basis of the document, a printing master copy in a standard format is generated.

Moreover, an identification feature that unambiguously identifies the printing master copy is incorporated into the printing master copy and, if applicable, the latter is provided with information to the effect that restricted access rights exist.

Subsequently, the printing master copy is encrypted in such a way that it can only be decrypted in the cryptographic module 70 of the reader 60. This is done, for example, on the basis of the public key of the reader 60 that is known to the authorization unit 90, and said public key is requested from the operating unit 30 by the authorization unit 90 or else it is transmitted from the operating unit 30 to the franking unit 10 in one of the preceding steps such as, for instance, the request for the printing master copy in step A1, and is forwarded by the franking unit 10 to the authorization unit 90. When a uniform public key of all readers 60 is used, the key is generally already known to the authorization unit 90.

In the authorization database 80, the authorization unit 90 stores an association between the identification feature of the printing master copy and information about the fact that the content of the printing master copy is not permitted to be permanently stored, copied or exported and that it may be printed out only one time. Here, especially the appertaining parameters and/or the appertaining values of parameters are entered into the authorization database 80.

Subsequently the encrypted printing master copy is transmitted from the authorization unit 90 to the operating unit 30 as is illustrated in the FIGURE by reference numeral A5.

In the area of the operating unit 30, the encrypted printing master copy is stored in the volatile memory and made available to the reader 60. In the cryptographic module 70 of the reader 60, the printing master copy is subsequently decrypted using the private key, it is recognized that this is a printing master copy that is linked to access rights, and the access rights are ascertained. This is illustrated in the FIGURE by reference numeral A6.

In the embodiment of the invention under consideration here, a query of the information about the access rights is sent from the cryptographic module 70 to the authorization unit 90, indicating the identification feature read out by the cryptographic module 70. On the basis of the entry in the authorization database 80, the authorization unit 90 ascertains the information about the access rights and transmits it to the reader 60, which then blocks the operating elements that are provided for executing functions that are not permitted to be carried out. In this manner, the reader blocks operating elements having to do with permanently storing, copying and exporting the printing master copy and with removing contents.

Moreover, it is provided that, each time a function is called up, the cryptographic module 70 sends a query about the authorization to execute that function to the authorization unit 90, the authorization is verified by the authorization unit 90 in the authorization database 80 and the result of this verification is sent back to the cryptographic module 70. The cryptographic module 70 of the reader 60 subsequently complies with this result and thus does not perform any functions for which no authorizations exist.

This is especially carried out in connection with the printing of the content of the printing master copy containing the postage indicium: the printing of the content of the printing master copy containing the postage indicium is carried out in the printing unit 40, complying with the access rights and controlled by the cryptographic module 70 and this is illustrated in the FIGURE by reference numeral A7.

In the embodiment of the invention under consideration here, the customer initiates the printing via an appropriate operating unit. Then the cryptographic module 70 of the reader 60 sends a request to the authorization unit 90 about the authorization for printing out the contents of the printing master copy, indicating the identification feature of the printing master copy. During a first request, on the basis of the entry in the authorization database 80 containing the association between the parameter relating to the printing and/or the value of a parameter relating to the printing, the authorization unit 90 recognizes that a first printing can be carried out and it sends a notification to the cryptographic module 70 of the reader 60 to the effect that the printing is permitted.

The content of the printing master copy is printed out in the printing unit 40 on the basis of the notification, whereby the printing unit 40 is controlled by the cryptographic module 70 of the reader 60. After the content of the printing master copy has been printed out or after the control command to print has been transmitted from the cryptographic module 70 of the reader 60 to the printing unit 40, the latter indicating the identification feature of the printing master copy transmits a notification about the printing of the content of the printing master copy to the authorization unit 90 which, on the basis of the notification, makes a change in the authorization database 80 to the parameter relating to the printing and/or to the value of a parameter relating to the printing, whereby the changed parameter or the changed value corresponds to information to the effect that printing of the content of the printing master copy is not permitted.

If a cryptographic module 70 of any reader 60 sends a renewed request to the authorization unit 90 about the authorization for printing out the content of the printing master copy, indicating the identification features of the printing master copy, the authorization unit 90 sees in the authorization database 80 that printing cannot be carried out and sends a notification to the cryptographic module 70 of the reader 60 from which the request had come, to the effect that the printing is not permitted. The printing of the content of the printing master copy is then blocked by the cryptographic module 70 of this reader 60.

In order for the cryptographic module 70 to transmit a notification about the printing of the content of the printing master copy to the authorization unit 90, it is provided that the latter sends a demand for the transmission of this notification, together with the notification to the effect that the printing is permitted, to the cryptographic module 70. This demand is complied with by the cryptographic module 70.

In a modification of this embodiment of the invention, it is provided that the parameter relating to the printing and/or the value of a parameter relating to the printing is changed in the above-mentioned manner already on the basis of the request regarding the authorization for printing out the content of the printing master copy, said request having been sent from the cryptographic module 70 to the authorization unit 90. This modification has the advantage that, even if the operating unit 30 is disconnected from the power supply or from the network via which it is connected to the authorization unit 90 immediately after the control command to print has been transmitted to the operating unit 40, this cannot prevent the parameter relating to the printing and/or the value of a parameter relating to the printing from being changed because of the printing.

In other embodiments of the invention, as already described above, it is proposed that the querying of the authorization database 80 be dispensed with. In these embodiments, the parameter relating to the printing and/or the value of a parameter relating to the printing is contained in the printing master copy or in a license. Analogously to the above-mentioned change of the parameter and/or of the value in the authorization database 80, this parameter or value is changed within the document or license when the content of the printing master copy is printed out. This is done in the area of the cryptographic module 70 in that the stored information about the printing is complied with at the time of subsequent printing attempts.

The depicted embodiments of the invention show that the invention allows a secure generation of postage indicia in which the production of the postage indicium and its printing can be completely uncoupled so that the operating unit 60 does not require any specialized equipment for generating and printing postage indicia.

### LIST OF REFERENCE NUMERALS

10 franking unit
20 security module
30 operating unit
40 printing unit
50 browser
60 reader
70 cryptographic module
80 authorization database
90 authorization unit
A1 request for a printing master copy with a valid postage indicium
A2 generation of a data record of the postage indicium
A3 transmission of the data record from the security module to the authorization unit
A4 generation and encryption of a printing master copy of the postage indicium from the data record, said printing master copy being linked to access rights
A5 transmission of the printing master copy from the authorization unit to the operating unit
A6 decryption of the printing master copy and determination of the access rights
A7 printing out of the postage indicium in a manner controlled by the cryptographic module

1-23. (canceled)

24. A method for franking mail, comprising:
generating a printing master copy of a postage indicium;
encrypting the printing master copy of the postage indicium;
transmitting the printing master copy to an operating unit, together with a request that information about the printing of the postage indicium is to be stored after the postage indicium has been printed out;
decrypting the printing master copy in a secure area of the operating unit in order to print the postage indicium, whereby the secure area is a component of a universal standard program for displaying and/or printing text and/or graphic elements; and
responsive to a request for printing the postage indicium, storing information about the printing in the printing master copy and/or in an authorization database, whereby a printing of the postage indicium is blocked if the information about the printing is already present.

25. The method according to claim 24, comprising performing a verification of whether information about the printing of the postage indicium is already present before the postage indicium is printed out.

26. The method according to claim 24, wherein the information about the printing of the postage indicium is incorporated into the printing master copy.

27. The method according to claim 24, wherein the printing master copy is encrypted in such a way that it can only be decrypted in a specific operating unit from which the postage indicium has been requested.

28. The method according to claim 24, wherein the information about the printing of the postage indicium is stored in an authorization database.

29. The method according to claim 24, wherein the printing master copy is encrypted in such a manner that it can only be decrypted by any one of a plurality of operating units that store information about the printing of the postage indicium after the postage indicium has been printed out and in that the plurality of operating units comply with the information about the printing of the postage indicium.

30. The method according to claim 24 the request is encrypted and then decrypted in the operating unit.

31. The method according to claim 24, wherein the request for printing is incorporated into the printing master copy.

32. The method according to claim 24, wherein the request for printing is incorporated into an encrypted license that is decrypted in the operating unit.

33. The method according to claim 24, wherein the printing master copy is decrypted in the operating unit using a key that is incorporated into an encrypted license.

34. The method according to claim 24, wherein the information about the printing of the postage indicium is incorporated into a license.

35. The method according to claim 24, wherein the printing master copy and/or an encrypted license are encrypted using a public key of the operating unit.

36. The method according to claim 24, wherein the printing master copy and/or an encrypted license are decrypted using a private key of the operating unit.

37. The method according to claim 36, wherein the private key is associated with a plurality of operating units.

38. The method according to claim 24, wherein the printing master copy and/or an encrypted license are encrypted and decrypted using identical keys.

39. The method according to claim 24, canceling the postage indicium after it is printed out in the operating unit.

40. A device for franking mail with a postage indicium, the device comprising:
an authorization unit that is adapted to encrypt a request to print the postage indicium, the request comprising an indication that information about a printing of the postage indicium is to be stored after the postage indicium has been printed;
a security module connected to the authorization unit, the security module being adapted to generate an encrypted printing master copy containing the postage indicium;
a control device that is adapted to print the postage indicium by controlling a printing unit; and
an operating unit that has a secure area that is a component of a universal standard program for displaying and/or printing text and/or graphic elements, the secure area being adapted to store the information about the printing of the postage indicium in the printing master copy and/or in an authorization database responsive to the request to print the postage indicium, the operating unit being adapted to decrypt the printing master copy and the request to print the postage indicium, the operating unit being further adapted to check for presence of the information about the printing of the postage indicium and to block the control device from printing the postage indicium if the information about the printing of the postage indicium is already present.

41. The device according to claim 40, wherein the authorization database comprises a portion of the authorization unit.

42. The device according to claim 40, wherein the authorization unit is associated with a plurality of operating units.

43. The device according to claim 40, wherein the operating unit is adapted to send a notification about the printing of the postage indicium to the authorization unit.

44. The device according to claim 40, wherein the operating unit is adapted to transmits a query about the presence of information about the printing of the postage indicium.

45. A tangible machine-readable medium, comprising:
code that is adapted to generate a printing master copy of a postage indicium;
code that is adapted to encrypt the printing master copy of the postage indicium;
code that is adapted to transmit the printing master copy to an operating unit, together with a request that information about the printing of the postage indicium is to be stored after the postage indicium has been printed out;
code that is adapted to decrypt the printing master copy in a secure area of the operating unit in order to print the postage indicium, whereby the secure area is a component of a universal standard program for displaying and/or printing text and/or graphic elements; and
code that is adapted to, responsive to a request for printing the postage indicium, store information about the printing in the printing master copy and/or in an authorization database, whereby a printing of the postage indicium is blocked if the information about the printing is already present.
